(19) United States
(12) Patent Application Publication
(10) Pub. No.: US 2023/0227685 A1
(43) Pub. Date: Jul. 20, 2023

(54) BIO-BASED FURANIC DI(METH)ACRYLATES AS REACTIVE DILUENTS FOR UV CURABLE COATINGS

(71) Applicant: NDSU RESEARCH FOUNDATION, Fargo, ND (US)

(72) Inventors: Dean C. WEBSTER, FARGO, ND (US); Mukund P' Sibi, Fargo, ND (US); Jingbo Wu, Fargo, ND (US); Catherine A. Sutton, Fargo, ND (US)

(21) Appl. No.: 18/051,678

(22) Filed: Nov. 1, 2022

Related U.S. Application Data
(60) Provisional application No. 63/274,274, filed on Nov. 1, 2021.

(51) Int. Cl. C09D 133/08; C09D 7/20; C09D 7/63

(52) U.S. Cl. CPC C09D 133/08; C09D 7/20; C09D 7/63

(57) ABSTRACT

The invention relates to a curable coating composition comprising: at least one acrylate functional oligomer; at least one furan-based reactive diluent; and at least one photoinitiator. The invention also relates to methods of making and using the curable coating composition of the invention. The invention also relates to a method for improving the hardness, abrasion resistance, and/or durability of an object or a substrate.

### CROSS-REFERENCE TO RELATED APPLICATIONS

This application claims priority to U.S. Provisional Application No. 63/274,274, filed Nov. 1, 2021, which is incorporated herein by reference.

### STATEMENT OF U.S. GOVERNMENT SUPPORT

This invention was made with government support under grant W911-NF-19-2-0138 awarded by the Army Research Laboratory. The U.S. government has certain rights in the invention.

### BACKGROUND OF THE INVENTION

UV-curing is of growing interest due to its unique economic and ecological advantages: ultrafast curing at ambient temperatures, 100% solids or low volatile organic compound (VOC) formulations, low energy usage, and high performance coatings.^{1, 2} As a result, UV curable coatings are widely used for printing, furniture, plastic substrates, optical fibers, wood flooring, headlight lenses, and metal substrates.³⁻⁵ Generally, a UV-curable system contains three indispensable components: reactive diluents, oligomer resins, and photoinitiators.⁶ Photopolymerizable reactive diluents are usually based on acrylate, vinyl, and epoxide groups and facilitate easy processing of the coating by lowering the viscosity of the formulation.^{7, 8} Furthermore, reactive diluents can increase cross-link density, enhance cure speed, and modify tensile properties of UV curable coatings.⁹ Currently, commercial reactive diluents are typically derived from petroleum-based products, which has caused sustainability concerns and stimulates the development of bio-based raw materials.¹⁰ Bio-based materials are often looked upon as inexpensive, nontoxic, abundantly available, and renewable raw materials for UV-curing applications.^{4,9, 11-15} A number of research studies have been carried out on modification and application of bio-based materials as resins or reactive diluents for UV curing, such as soybean oil based acrylates,¹⁶ castor oil based diacrylates or triacrylates,^{7,17} cardanol based acrylate,^{18, 19} and tung oil based methacrylate.²⁰

5-Hydroxymethylfurfural (HMF)²¹ is a promising biomass-derived compound with great potential for the synthesis of biofuels, polymers, solvents, pharmaceuticals and other useful molecules.^{22, 23} In the area of polymer synthesis, the glycidyl ester of furan dicarboxylic acid (FDCA) has been synthesized and thermosets made with different curing chemistries.^{24, 25} The glycidyl ester of FDCA has also been reacted with methacrylic acid to form the dimethacrylate and thermosets were made by thermal free radical polymerization.²⁶ The dimethacrylate of bis-hydroxymethyl furan was synthesized and used as a monomer to prepare polymeric materials via proton-transfer polymerization.²⁷ The diacrylate of bis-hydroxymethyl furan has been used in thiol-Michael addition polymerization.^{28, 29} However, (meth)acrylated HMF derivatives have not been used in UV curable coatings.

Recently, a series of symmetric and non-symmetric diols derived from HMF were synthesized in high yields using an operationally simple protocol.³⁰ Several of these diols were found to exhibit no endocrine activity in several assays. The invention describes the use of these diols in polymer applications, and the synthesis of acrylate and methacrylate derivatives of the diols and their use in polymer applications.

### SUMMARY OF THE INVENTION

The invention relates to a curable coating composition, comprising, consisting essentially of, or consisting of: at least one acrylate functional oligomer; at least one furan-based reactive diluent; and at least one photoinitiator.

The invention further relates to a method of making the curable coating composition of the invention.

The invention also relates to the furan-based reactive diluents used in the curable coating compositions of the invention and a process for preparing them.

The invention also relates to a cured coating composition of the invention.

The invention further relates to an object or a substrate coated with the curable coating composition of the invention, which may then be cured for a coating.

The invention also relates to a method for improving the hardness, abrasion resistance, and/or durability of an object or a substrate.

### BRIEF DESCRIPTION OF THE FIGURES

FIG. 1 shows the ¹H NMR spectrum of FDA-5.

FIG. 2 shows the viscosities of HDDA and the furan-based diluents.

FIG. 3 shows the viscosities of the formulated samples of Ebecryl® 1290 and reactive diluents.

FIG. 4A and FIG. 4B show the storage modulus and loss factor, respectively, of the UV cured films using HDDA, FDA-1, and FDMA-1 as diluents.

FIG. 5 shows the TGA curves of the UV-cured film samples using different diluents.

FIG. 6 shows the ATR-FTIR spectrum of FDA-5.

FIG. 7 shows the ATR-FTIR spectrum of cured film using FDA-1 as a diluent.

FIG. 8 shows the ATR-FTIR spectrum of cured film using FDMA-1 as a diluent.

FIG. 9 shows the storage modulus and loss factor of the UV cured film using FDA-2 as a diluent.

FIG. 10 shows the storage modulus and loss factor of the UV cured film using FDA-3 as a diluent.

FIG. 11 shows the storage modulus and loss factor of the UV cured film using FDA-5 as a diluent.

FIG. 12 shows the storage modulus and loss factor of the UV cured film using FDA-6 as a diluent.

FIG. 13 shows the storage modulus and loss factor of the UV cured film using FDA-7 as a diluent.

FIG. 14 shows the storage modulus and loss factor of the UV cured film using FDA-8 as a diluent.

FIG. 15 shows the storage modulus and loss factor of the UV cured film using FDA-9 as a diluent.

FIG. 16 shows the storage modulus and loss factor of the UV cured film using FDMA-1 as a diluent.

FIG. 17 shows the storage modulus and loss factor of the UV cured film using FDMA-2 as a diluent.

FIG. 18 shows the storage modulus and loss factor of the UV cured film using FDMA-3 as a diluent.

FIG. 19 shows the storage modulus and loss factor of the UV cured film using FDMA-4 as a diluent.

FIG. 20 shows the storage modulus and loss factor of the UV cured film using FDMA-5 as a diluent.

FIG. 21 shows the storage modulus and loss factor of the UV cured film using FDMA-6 as a diluent.

FIG. 22 shows the storage modulus and loss factor of the UV cured film using FDMA-7 as a diluent.

FIG. 23 shows the storage modulus and loss factor of the UV cured film using FDMA-8 as a diluent.

FIG. 24 shows the storage modulus and loss factor of the UV cured film using FDMA-9 as a diluent.

FIG. 25 shows the DSC curves of the UV cured film using HDDA as a diluent.

FIG. 26 shows the DSC curves of the UV cured film using FDA-1 as a diluent.

FIG. 27 shows the DSC curves of the UV cured film using FDA-2 as a diluent.

FIG. 28 shows the DSC curves of the UV cured film using FDA-3 as a diluent.

FIG. 29 shows the DSC curves of the UV cured film using FDA-4 as a diluent.

FIG. 30 shows the DSC curves of the UV cured film using FDA-5 as a diluent.

FIG. 31 shows the DSC curves of the UV cured film using FDA-6 as a diluent.

FIG. 32 shows the DSC curves of the UV cured film using FDA-7 as a diluent.

FIG. 33 shows the DSC curves of the UV cured film using FDA-8 as a diluent.

FIG. 34 shows the DSC curves of the UV cured film using FDA-9 as a diluent.

FIG. 35 shows the DSC curves of the UV cured film using FDMA-1 as a diluent.

FIG. 36 shows the DSC curves of the UV cured film using FDMA-2 as a diluent.

FIG. 37 shows the DSC curves of the UV cured film using FDMA-3 as a diluent.

FIG. 38 shows the DSC curves of the UV cured film using FDMA-4 as a diluent.

FIG. 39 shows the DSC curves of the UV cured film using FDMA-5 as a diluent.

FIG. 40 shows the DSC curves of the UV cured film using FDMA-6 as a diluent.

FIG. 41 shows the DSC curves of the UV cured film using FDMA-7 as a diluent.

FIG. 42 shows the DSC curves of the UV cured film using FDMA-8 as a diluent.

FIG. 43 shows the DSC curves of the UV cured film using FDMA-9 as a diluent.

FIG. 44 shows the TGA curves of the UV cured films using FDA-2 and FDMA-2 as a diluent, respectively.

FIG. 45 shows the TGA curves of the UV cured films using FDA-3 and FDMA-3 as a diluent, respectively.

FIG. 46 shows the TGA curves of the UV cured films using FDA-4 and FDMA-4 as a diluent, respectively.

FIG. 47 shows the TGA curves of the UV cured films using FDA-5 and FDMA-5 as a diluent, respectively.

FIG. 48 shows the TGA curves of the UV cured films using FDA-6 and FDMA-6 as a diluent, respectively.

FIG. 49 shows the TGA curves of the UV cured films using FDA-7 and FDMA-7 as a diluent, respectively.

FIG. 50 shows the TGA curves of the UV cured films using FDA-8 and FDMA-8 as a diluent, respectively.

FIG. 51 shows the TGA curves of the UV cured films using FDA-9 and FDMA-9 as a diluent, respectively.

### DETAILED DESCRIPTION OF THE INVENTION

The invention relates to curable coating composition, comprising, consisting essentially of, or consisting of: at least one acrylate functional oligomer; at least one furan-based reactive diluent; and at least one photoinitiator.

The acrylate functional oligomer may be selected from the group consisting of a urethane acrylate oligomer, an epoxy acrylate oligomer, a polyester acrylate oligomer, a polyether acrylate oligomer, and mixtures thereof. For example, the urethane acrylate oligomer may be selected from the group consisting of an aliphatic urethane acrylate oligomer, an aromatic urethane acrylate oligomer, and mixtures thereof. Preferably, the aliphatic urethane acrylate oligomer is a hexafunctional aliphatic urethane acrylate oligomer (e.g., Ebecryl® 1290).

The acrylate functional oligomer may be present in the curable coating composition in an amount ranging from about 20-90 parts per hundred resin (PHR) (e.g., about 30-80, about 40-70, about 50-60), based on the total weight of the curable coating composition. Preferably, the acrylate functional oligomer is present in the curable coating composition in an amount of about 80 PHR, based on the total weight of the curable coating composition.

The furan-based reactive diluent may be selected from the group consisting of Formulae (I), (II), (III), and mixtures thereof:

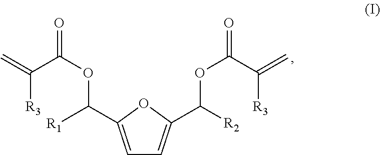

wherein:

R₁ and R₂ are, independent of one another, H, a C₁₋₆ alkyl, a C₂₋₆ alkenyl, a C₂₋₆ alkynyl, C₃₋₇ cycloalkyl, or aryl, wherein C₁₋₆ alkyl, C₂₋₆ alkenyl, C₂₋₆ alkynyl, C₃₋₇ cycloalkyl, and aryl are optionally substituted with substituents selected from OH, O—C₁₋₃ alkyl, and aryl, and wherein the C₃₋₇ cycloalkyl is optionally partially unsaturated and optionally at least one carbon atom in the cycloalkyl ring is replaced with a heteroatom; and

R₃ is, at each occurrence independent of one another, H or a C₁₋₆ alkyl;

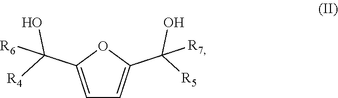

wherein:

R₄, R₅, R₆, and R₇ are independently selected from the group consisting of H, C₁-C₆alkyl, C₂-C₆alkenyl, aryl, and C₁-C₆alkyl-aryl; and

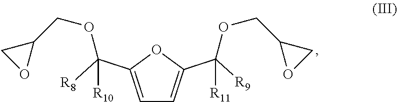

wherein:

R₈, R₉, R₁₀, and R₁₁ are independently selected from the group consisting of H, C₁-C₆alkyl, C₂-C₆ alkenyl, aryl, and C₁-C₆alkyl-aryl.

As used herein, the term “alkyl” refers to a linear or branched, saturated hydrocarbon group typically containing 1 to 24 carbon atoms, preferably 1 to 12 carbon atoms, more preferably 1 to 6 carbon atoms: such as methyl, ethyl, n-propyl, iso-propyl, n-butyl, iso-butyl, tert-butyl, pentyl, hexyl, and the like.

As used herein, the term “alkenyl” refers to a linear or branched hydrocarbon group of 2 to 24 carbon atoms containing at least one double bond, such as ethenyl, n-propenyl, iso-propenyl, n-butenyl, iso-butenyl, octenyl, decenyl, tetradecenyl, hexadecenyl, and the like. Preferred alkenyl groups herein contain 2 to 12 carbon atoms, more preferred alkenyl groups herein contain 2 to 6 carbon atoms.

As used herein, the term “alkynyl” refers to a linear or branched hydrocarbon group of 2 to 24 carbon atoms containing at least one triple bond, such as ethynyl, n-propynyl, and the like. Preferred alkynyl groups herein contain 2 to 12 carbon atoms, more preferred alkynyl groups herein contain 2 to 6 carbon atoms.

As used herein, the term “cycloalkyl” refers to a cyclic alkyl group, can be monocyclic, bicyclic, or polycyclic, typically having 3 to 10, preferably 5 to 7, carbon atoms, generally, cycloalkyl groups are cyclopentyl, cyclohexyl, adamantly, and the like.

As used herein, the term “aryl” refers to an aromatic substituent containing a single aromatic ring or multiple aromatic rings that are fused together, directly linked, or indirectly linked (such that the different aromatic rings are bound to a common group such as a methylene or ethylene moiety). Preferred aryl groups contain 5 to 24 carbon atoms, and particularly preferred aryl groups contain 6 to 10 carbon atoms. Exemplary aryl groups contain one aromatic ring or two fused or linked aromatic rings, e.g., phenyl, naphthyl, biphenyl, diphenylether, diphenylamine, benzophenone, phenanthryl, and the like.

Preferably, the furan-based reactive diluent has the structure of Formula (I), wherein R₁, R₂, and R₃ are as defined herein. More preferably, R₁ and R₂ are, independent of one another, H, a C₁₋₄ alkyl, a C₂₋₄ alkenyl, and C₄₋₆ cycloalkyl; and R₃ is, at each occurrence independent of one another, H or a C₁₋₃ alkyl. Even more preferably, R₁ and R₂ are, independent of one another, H, methyl, ethyl, propyl, butyl, —CH₂(CH═CH₂), or

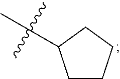 [SMILES: *C1CCCC1]

and R₃ is H or methyl. For example, the furan-based reactive diluent of Formula (I) may be selected from the group consisting of:

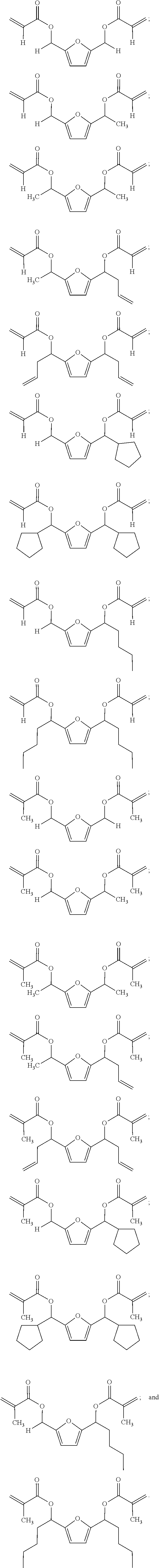

The furan-based reactive diluent of Formula (I) may comprise, consist essentially of, or consist of the reaction product of a furan-based diol and an acyl chloride, wherein the furan-based diol may have the following structure:

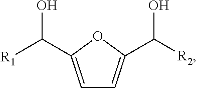

and the acyl chloride may have the following structure:

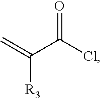

wherein R₁, R₂, and R₃ are as defined herein. Preferably, the acyl chloride is acryloyl chloride or methacryloyl chloride. The invention, thus, also relates to the furan-based reactive diluents of Formula (I) and a process for preparing the furan-based reactive diluents of Formula (I), comprising, consisting essentially of, or consisting of adding, for example, triethylamine to the furan-based diol to form a first mixture; and adding an acyl chloride (e.g., acryloyl chloride or methacryloyl chloride) to the first mixture.

Further examples and description of reactive diluents of Formulae (II) and (III) are described in WO 2021/007171, incorporated herein by reference.

The furan-based reactive diluent may be present in the curable coating composition in an amount of about 5-95 PHR (e.g., about 10-80, about 20-70, about 30-60, about 40-50), based on the total weight of the curable coating composition. Preferably, the furan-based reactive diluent may be present in the curable coating composition in an amount of about 20 PHR, based on the total weight of the curable coating composition.

Any photoinitiator known in the art may be used. Preferably, the photoinitiator is Irgacure® 1173. The photoinitiator may be present in the curable coating composition in an amount ranging from about 0.5-10 PHR (e.g., about 1-8, about 2-6, about 3-4), based on the total weight of the curable coating composition. Preferably, the photoinitiator is present in the curable coating composition in an amount of about 2 PHR, based on the total weight of the curable coating composition.

The invention also relates to a method of making the curable coating composition of the invention comprising, consisting essentially of, or consisting of combining the at least one acrylate functional oligomer, the at least one furan-based reactive diluent, and the at least one photoinitiator.

The invention also relates to a cured coating composition, wherein the curable coating composition of the invention is cured by radiation (e.g., ultraviolet radiation or visible light radiation) to form the cured coating composition.

The invention also relates an object (e.g., flat objects, dental composites, 3D stereolithography (SLA) printing, etc.) or substrate (e.g., paper, polyester films such as polyethylene and polypropylene, metals such as aluminum and steel, glass, urethane elastomers, primed (painted) substrates, and the like) coated with the curable coating composition of the invention, which may then be cured to for a coating. The curable coating compositions of the invention may be coated onto an object or a substrate and cured using techniques known in the art.

The invention further relates to a method for improving the hardness, abrasion resistance, and/or durability of an object or a substrate, comprising, consisting essentially of, or consisting of the steps of: coating at least a portion of a surface of the object or the substrate with the curable coating composition of the invention to form a coated surface, and curing the curable coating composition on the coated surface.

Pigments and other additives known in the art to control coating rheology and surface properties can also be incorporated in a curable coating composition of the invention. For example, a curable coating composition of the invention may further contain coating additives. Such coating additives include, but are not limited to, one or more leveling, rheology, and flow control agents such as silicones, fluorocarbons, or cellulosics; extenders; reactive coalescing aids such as those described in U.S. Pat. No. 5,349,026, incorporated herein by reference; plasticizers; flatting agents; pigment wetting and dispersing agents and surfactants; ultraviolet (UV) absorbers; UV light stabilizers; tinting pigments; colorants; defoaming and antifoaming agents; anti-settling, anti-sag and bodying agents; anti-skinning agents; anti-flooding and anti-floating agents; biocides, fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005. Further examples of such additives may be found in U.S. Pat. No. 5,371,148, incorporated herein by reference.

Solvents may also be added to the curable coating formulation to reduce the viscosity. Hydrocarbon, ester, ketone, ether, ether-ester, alcohol, or ether-alcohol type solvents may be used individually or in mixtures. Examples of solvents can include, but are not limited to, benzene, toluene, xylene, aromatic 100, aromatic 150, acetone, methylethyl ketone, methyl amyl ketone, butyl acetate, t-butyl acetate, tetrahydrofuran, diethyl ether, ethylethoxy propionate, isopropanol, butanol, butoxyethanol, etc.

### EXAMPLES

A series of nine acrylated furan-based diols and nine methacrylated furan-based diols were synthesized and characterized. These were then incorporated into a UV curable coating formulation as reactive diluents and the effect of the diluents on formulation viscosity was assessed. The coatings were then cured and screened for their viscoelastic (dynamic mechanical analysis), thermal stability (thermogravimetry) and mechanical properties (nanoindentation). A control system using a common diluent, hexanediol diacrylate, was prepared for comparison.

Materials

Acryloyl chloride (97%, contains <210 ppm monomethyl ether hydroquinone (MEHQ) as stabilizer), methyacryloyl chloride (97% contains ^{˜}200 ppm MEHQ as stabilizer), dichloromethane (anhydrous, >99.8%), triethylamine (TEA, >99.5%), tetrahydrofuran (anhydrous, 99.9%), Grignard reagents, and standardized aluminum oxide 90 were purchased from Sigma-Aldrich. Chloroform-d, thin layer chromatography (TLC) plates, hydroquinone (HQ, 99%), and anhydrous magnesium sulfate were purchased from VWR. Hexanediol diacrylate (HDDA) and Ebecryl® 1290 (aliphatic urethane acrylate) were provided by Allnex. Irgacure® 1173 (HMPP, 2-hydroxy-2-methyl propiophenone) photoinitiator was received from BASF. 5-Hydroxymethylfurfural was purchased from Avantium. It was purified before use. 2,5-bishydroxymethylfuran and the symmetric and non-symmetric furan-based diols were synthesized by following previously reported procedures.³⁰ Unless otherwise stated, all commercially procured reagents were used as received without further purification.

Spectroscopic Analysis of the Diluents

Diluents were characterized at 25° C. using a JEOL EAC series 400 MHz nuclear magnetic resonance spectrometer CH NMR and ¹³C NMR) and processed with Topspin software. Solutions of the diluents in deuterated chloroform (99.8%; one assessment with 1% TMS) were prepared. Fourier transform infrared spectroscopy (FTIR) was done using a Thermo Nicolet 8700 FTIR spectrometer. Spectral acquisitions were done in the range of 4000-500 cm⁻¹ based on 32 scans with data spacing of 4.0 cm⁻¹.

Viscosity Determination

An ARES G2 parallel plate rheometer from TA Instruments was used for viscosity determinations. The materials were applied onto the bottom plate using a pipette and the gap was set at 1 mm. Any excess material was removed using a KimWipe. The plate was rotated at a steady rate from 1 to 100 rotations/s.

UV Curable Formulation and Coating Preparation

The UV curable baseline coating formulation was prepared using the Ebecryl® 1290 (80 PHR), reactive diluents (20 PHR), and a photoinitiator (2 PHR). A common reactive diluent, HDDA, was used as a control. Formulations were prepared using the furan-based reactive diluents. The resin was mixed with the reactive diluents and photoinitiator using a high-speed mixer at room temperature to ensure complete homogeneity. The films were drawn down at 7 mils wet thickness on iron phosphated ground steel panels (Q-Panel, S-36-I). The coatings were cured using a Fusion LC6B Benchtop Conveyer with an F300 UV lamp in air. A UV Power Puck II from EIT Inc. was used to measure the UV-light intensity. UV-lamp intensities for different UV-radiation types are listed as follows: UVV (395-445 nm) is 1192 mW/cm², UVA (390-320 nm) is 1505 mW/cm², UVB (320-280 nm) is 398 mW/cm², and UVC (260^{˜}250 nm) is 72 mW/cm². The overall curing method was to pass the coating through the lamp at a conveyer belt speed of 6 ft/min (˜20 s exposure) and repeat once to obtain a tack free, through cured film. The coatings were stored at ambient overnight prior to characterization of their performance. The thickness of the cured coatings was 90-110 μm, which was determined using a Byko-Test 8500 coating thickness gauge.

Properties of Coatings

Koenig pendulum hardness of the coatings was determined following ASTM D 4366 and reported in seconds (s). Reverse impact strength of the cured coatings was determined using a Gardener impact tester following ASTM D 2794. The drop weight was 4 lb and the maximum drop height was 43 in. Loss of adhesion or surface crazing was noted and the inch-pounds (in-lb) were reported at film finish failure. The methyl ethyl ketone (MEK) double rubs method was used according to ASTM D 5402 to assess the development of cure and chemical resistance of the cured films. To carry out the test, three layers of cheesecloth was wrapped around the hammerhead of a 26-oz hammer and was soaked in MEK. The cheesecloth was rewet with MEK after 30-50 double rubs. At the point that mar was observed on the coating surface, the number of double rubs was noted. A Gardco crosshatch adhesion instrument was used to assess the crosshatch adhesion of the coatings following ASTM D 3359.

Differential Scanning Calorimetry (DSC)

A Q1000 modulated differential scanning calorimeter (DSC, TA Instruments) with an autosampler accessory was used to determine the glass transition temperature (T_{g}) of the coatings. Approximately 5 mg of coating film was placed in an aluminum sample pan and run under a heat-cool-heat regime first equilibrating at 30° C., heating at 10° C./min to 250° C., cooling 10° C./min to 20° C., and then reheating at 10° C./min to 250° C. Dry N2 gas was purged through the DSC cell with a flow rate of 50 mL/min. T_{g} was determined as the midpoint of the inflection in the second heating.

Dynamic Mechanical Analysis (DMA)

A Q850 Dynamic Mechanical Analysis system (TA Instruments) was used to determine viscoelastic properties of the cured coating films. The free films were 20-30 mm in length, 5 mm in width, and 0.09-0.12 mm in thickness. The experiments were run in tensile mode using a temperature range of 50° C. to 250° C. with a ramp rate of 5° C./min at a frequency of 1 Hz.

Thermogravimetric Analysis (TGA)

TGA experiments were performed using a Q500 thermogravimetric analyzer (TGA, TA Instruments). Platinum pans that had been tared were loaded with ˜5-10 mg of the cured film samples before being heated under nitrogen from room temperature to 700° C. at a rate of 10° C./min and a nitrogen flow rate of 60 mL/min. The weight retained was recorded as a function of temperature.

Nano-Indentation Experiments

Nano-indentation experiments were conducted to evaluate the nanomechanical properties of the UV cured thin films on the steel panel using a Hysitron Ti 900 triboindenter in-situ system with a diamond Berkovich indenter with automation (24 indenters per sample). In this method, a depth sensing indenter is pressed into a material at a specified load, and the resulting data of load versus displacement are recorded and used to determine elastic modulus and hardness. Calibration was performed before measurements. Four different areas were chosen for each sample and six indentations were measured for each area. A total of 24 indents were measured for each sample. Prior to every indent, the indenter was first held in contact with the surface, to allow for stabilization of the piezoactuator (35 s) as well as drift correction (40 s), at a contact load of only 0.5 mN to prevent any deformation prior to the indentation experiment. The drift rate (typically, 0.1 nm 21 s) was determined automatically over the second 20 s period of the 40 s test. After raising the tip to 30 nm and approaching the surface again (surface detection at a load of 0.5 mN), the tip was then loaded to maximum load of 2000 μN within 5 s, held at the maximum load for a duration of 5 s and then unloaded in 5 s. Six measurements with a spacing of 60 μm apart were performed per sample and the first measurement was removed from the analysis to further reduce the influence of drift that may have occurred. The elastic modulus (E) and hardness (H) were then calculated from the load-displacement curves using the standard Oliver-Pharr method³¹ by the instrument software.

General Procedure for the Synthesis of the Furan-Based Reactive Diluents

Triethylamine (4 eq.) was added to a solution of furan-based diol (1 eq.) in anhydrous dichloromethane at 0° C. under a nitrogen atmosphere. The mixture was stirred at 0° C. for 10 mins. Acryloyl chloride or methacryloyl chloride (3.0 eq.) in anhydrous dichloromethane was slowly added to the solution (over 3-4 hours), and the reaction mixture was stirred overnight at room temperature. A deep red solution was formed. After the reaction, hexane was added into reaction solution and the mixture was stirred for an additional 15 mins. The precipitate was filtered. The filtrate was concentrated by rotary evaporation. The resulting residue was dissolved in a mixture of ethyl acetate and hexane, and then washed with brine, dried with anhydrous MgSO₄, then filtered and concentrated under vacuum to give a deep brown oil. To purify the crude product, a mixture of ethyl acetate and hexane (volume ratio is 10:1) was added to the deep brown oil. A brown precipitate was formed and filtered. The resulting solution was passed through a plug of aluminum oxide twice and washing using a mixture of ethyl acetate and hexane (volume ratio is 4:1) to yield pure light yellow diluents after removing all solvents.

Results and Discussion

Synthesis of Characterization of Furfural-Based Diluents

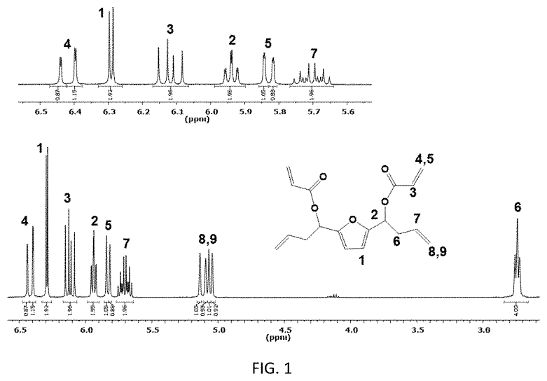

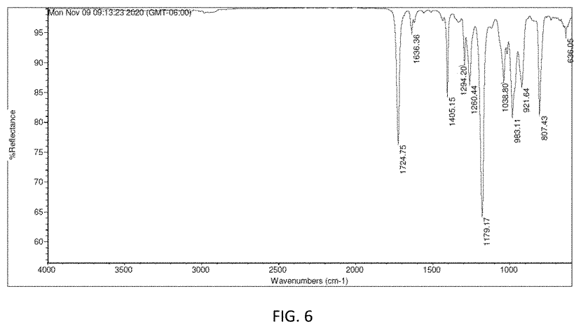

Four non-symmetric and five symmetric diols were prepared from biomass-derived feedstock 5-hydroxymethyl furfural (HMF) and 2,5-diformyl furan (DFF) according to a previously published procedure.³² The furan-based diols tended to slowly degrade and were immediately used to prepare diluents when they were synthesized. According to a modified literature procedure,²⁹ the diols were coupled with acryloyl chloride or methacryloyl chloride to yield the corresponding furan-based diluents FDA 1-9 (diacrylates, Scheme 1) and FDMA 1-9 (dimethacrylates, Scheme 1), respectively. To ensure the complete conversion of the hydroxyl groups, the molecular ratio of diol and acid chloride was 1:3. Since the furan group is not stable in acidic conditions, an excess of triethylamine was used to neutralize the HCl byproduct and to maintain the solution basic. The molar ratio of diol and triethylamine was 1:4. All furanic diols except for 2,5-bishydroxymethyl furan (BHMF) had good solubility in dichloromethane, thus, dichloromethane was used as a solvent instead of THF used in the previous literature. A small amount of dry THF was used to completely dissolve BHMF for the syntheses of FDA-1 and FDMA-1. Scheme 1 lists the isolated yields for the asymmetric and symmetric diluents prepared using our modified procedure. In a previous study,²⁹ a silica gel column was used to purify 2,5-furan diacrylate. The furan-based diacrylates or dimethacrylates seemed to be unstable on acidic silica gel. So, basic aluminum oxide was used to purify the diluents, and this yielded better results. ¹H and ¹³C NMR (CDCl₃) spectroscopic analyses indicated that all synthesized diluents were prepared in good purity without running column chromatography. The structures of the resulting diluents were further confirmed from ATR-FTIR and HRMS spectroscopy. For example, the ¹H NMR spectrum of the non-symmetric furan-based diluent FDA-5 is shown in FIG. 1. From FIG. 1, the characteristic multiple peaks at 2.84^{˜}2.66 ppm are assigned to the —CH₂ (6) in allyl groups, the four peaks at 5.04^{˜}5.16 ppm correspond to the —CH₂ (8 and 9) in the double bond of allyl groups, the doublet of doublet of triplets at 5.70 ppm are assigned to —CH (7) in the double bond of the allyl groups, the two doublet peaks at 6.44 ppm and 6.40 ppm plus two multiple peaks at 5.16-5.12 and 5.11-5.08 correspond to the —CH₂ (4 and 5) in the double bond of acrylate groups, the doublet of doublets at 6.12 ppm are assigned to the —CH (3) in the double of acrylate group, the triplet of doublets at 5.94 ppm are assigned to the —CH (2) on the substituted carbon next to furan ring, and the doublet peaks at 6.29 ppm correspond to the two hydrogens (1) on the furan ring. As shown in FIG. 6, the ATR-FTIR spectrum of FDA-5 shows the characteristic peak of acrylate double bond at 808 cm⁻¹, which confirms the successful formation of acrylate diluents. The methyl, allyl, cyclopentyl, and n-butyl groups were introduced to examine possible structure-property relationships for UV curable coatings.

Scheme 1. The synthesis of furan-based diacrylates and dimethacrylates.

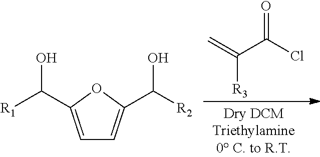

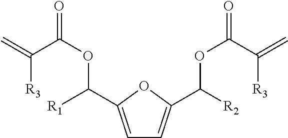

| Sample | R₁ | R₂ | R₃ | Yield (%) |
|---|---|---|---|---|
| FDA-1 | H | H | H | 90 |
| FDA-2 | H | —CH₃ | H | 78 |
| FDA-3 | —CH₃ | —CH₃ | H | 88 |
| FDA-4 | H | —C₃H₅ | H | 71 |
| FDA-5 | —C₃H₅ | —C₃H₅ | H | 88 |
| FDA-6 | H | —C₅H₉ | H | 77 |
| FDA-7 | —C₅H₉ | —C₅H₉ | H | 62 |
| FDA-8 | H | —C₄H₉ | H | 69 |
| FDA-9 | —C₄H₉ | —C₄H₉ | H | 78 |
| FDMA-1 | H | H | CH₃ | ~100 |
| FDMA-2 | H | —CH₃ | CH₃ | 91 |
| FDMA-3 | —CH₃ | —CH₃ | CH₃ | 82 |
| FDMA-4 | H | —C₃H₅ | CH₃ | 94 |
| FDMA-5 | —C₃H₅ | —C₃H₅ | CH₃ | 93 |
| FDMA-6 | H | —C₅H₉ | CH₃ | 99 |
| FDMA-7 | —C₅H₉ | —C₅H₉ | CH₃ | 72 |
| FDMA-8 | H | —C₄H₉ | CH₃ | 82 |
| FDMA-9 | —C₄H₉ | —C₄H₉ | CH₃ | 69 |

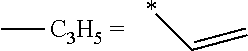

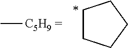

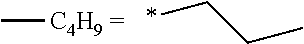

Viscosity of Diluents and Resin Blends

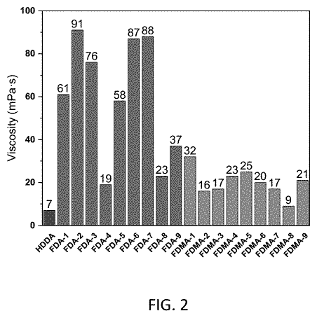

The furan-based diacrylates and dimethacrylates were evaluated rheologically to determine their viscosity profile for use as diluents in UV curable resins. The furan-based diluents exhibited Newtonian behavior and had viscosities ranging from 9-91 mPa·s at room temperature; the results of which are summarized in FIG. 2. A typical commercial diacrylate, 1,6-hexanediol diacrylate (HDDA), has a viscosity of 7 mPa·s at room temperature. The viscosities of furan-based diluents are somewhat higher than the commercial HDDA, as would be expected due to the presence of the furan ring. Dimethacrylates (FDMAs) exhibited lower viscosity in comparison to their corresponding diacrylate analogs (FDAs). It is typical that methacrylate functional compounds have lower viscosity than the corresponding acrylate compounds. Presumably the methyl group reduces the polarity of the compound and leads to a lower viscosity.

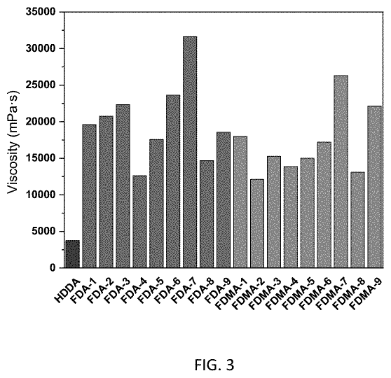

To enable a direct comparison with commercial UV curable resins, the furan-based diluents were blended with the urethane-based Ebecryl® 1290, a typical acrylate functional UV curable resin used for commercial applications. HDDA was used as a control. Samples were blended at a composition ratio of 80:20 (Ebecryl® 1290: diluents) and analyzed rheologically using steady state shear at room temperature and the results are illustrated in FIG. 3. The blended furan-based samples possessed higher viscosities than that of the commercial HDDA blended sample. The oxygen atom on the furan ring may produce hydrogen bonding and increase resin viscosity. The rigid furan ring may also increase resin viscosity compared to the linear aliphatic chain of HDDA.

Coating Properties

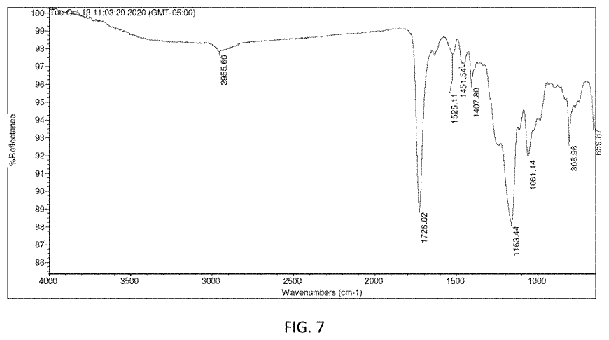

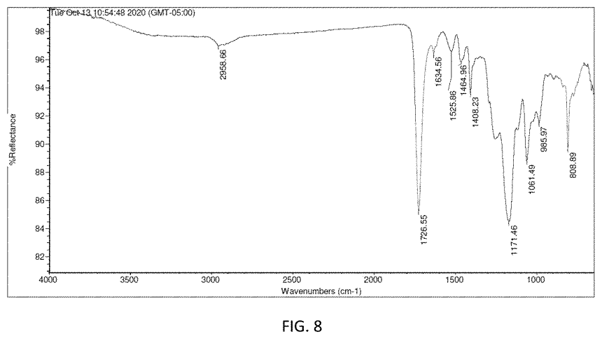

UV curable coatings formulations were prepared using a mixture of 20 PHR reactive diluent, 80 PHR Ebecryl® 1290, and 2 PHR photoinitiator, Irgacure® 1173. The commercial diluent HDDA was used as a control. The formulations were cured by passing the coating through the UV lamp system at the conveyor belt speed of 6 ft/min (^{˜}20 s exposure per pass) until a tack free through dry film was obtained. Both HDDA and the bio-based furfural diluent coating formulations produced highly cross-linked dry films in 2 passes. This indicated that the furan-based diluents have similar reactivity to HDDA. The cured film samples exhibit similar ATR-FTIR spectra. As shown in FIG. 7, ATR-FTIR studies on the cured films using furan-based diacrylates (e.g., FDA-1) as a diluent showed that the characteristic peak of acrylate groups at 809 cm⁻¹ remains, which indicates the formulations were not fully cured. As shown in FIG. 8, ATR-FTIR spectra of the cured films using furan-based dimethacrylates (e.g., FDMA-1) as a diluent also showed the characteristic peak of acrylate groups at 809 cm⁻¹, however, the characteristic peak of methacrylate groups at 940 cm⁻¹ (attributed to ═CH₂ wagging³³⁻³⁵) was not obviously observed in the spectra, which indicate most methacrylate groups from the diluents were reacted during the curing process and some acrylate groups from urethane acrylate resin remained in the film. It is well known that highly functional UV cured systems often reach a vitrification point, reducing mobility of the functional groups and limiting the conversion of functional groups.

Table 1 shows the properties of the UV cured coatings. All coatings had good chemical resistance indicated by MEK double rub values. All coatings had high pendulum hardness values but were also very brittle, as determine by reverse impact. Adhesion to iron phosphated steel was poor for all coatings, including the control, which is fairly typical for UV cured coatings.

TABLE 1
Properties of the UV cured coatings.

| | MEK | Reverse | Cross-Hatch | |
|---|---|---|---|---|
| | Double | Impact | Adhesion | Pendulum |
| Coating | Rubs | (In · Lb) | (5b = Best) | Hardness (S) |
| HDDA | >400 | 16 | 0B | 184 |
| FDA-1 | >400 | 12 | 1B | 187 |
| FDA-2 | >400 | 16 | 0B | 183 |
| FDA-3 | >400 | 16 | 2B | 181 |
| FDA-4 | >400 | 4 | 0B | 189 |
| FDA-5 | >400 | 8 | 1B | 180 |
| FDA-6 | >400 | 12 | 1B | 186 |
| FDA-7 | >400 | 12 | 0B | 179 |
| FDA-8 | >400 | 16 | 1B | 178 |
| FDA-9 | >400 | 8 | 1B | 172 |
| FDMA-1 | >400 | 12 | 0B | 131 |
| FDMA-2 | >400 | 16 | 0B | 130 |
| FDMA-3 | >400 | 20 | 1B | 129 |
| FDMA-4 | >400 | 4 | 0B | 177 |
| FDMA-5 | >400 | 8 | 0B | 185 |
| FDMA-6 | >400 | 12 | 0B | 186 |
| FDMA-7 | >400 | 4 | 0B | 178 |
| FDMA-8 | >400 | 12 | 0B | 180 |
| FDMA-9 | >400 | 12 | 1B | 178 |

TABLE 2
The thermal and mechanical properties of the UV cured coatings

| | | | Nano-Indentation | | | | |
|---|---|---|---|---|---|---|---|
| | DMA | | | Elastic | | | Char |
| | T_{g} | E’₂₅ | Hardness | Modulus | T_{d}^{5%} | Tₚ | Yield |
| Coating | (° C.) | (MPa) | (MPa) | (GPa) | (° C.) | (° C.) | (%) |
| HDDA | 100 | 2519.0 | 350.4 ± 2 | 5.39 ± 0.02 | 378 | 476 | 11 |
| FDA-1 | 147 | 3968.4 | 473.5 ± 1.5 | 6.03 ± 0.02 | 328 | 460 | 14 |
| FDA-2 | 140 | 3536.9 | 438.3 ± 1.4 | 5.93 ± 0.03 | 336 | 470 | 16 |
| FDA-3 | 148 | 2475.3 | 394.0 ± 1.4 | 5.87 ± 0.02 | 325 | 469 | 14 |
| FDA-4 | — | — | 457.7 ± 2.9 | 6.00 ± 0.04 | 346 | 469 | 17 |
| FDA-5 | 129 | 1923.8 | 469.5 ± 10.5 | 5.73 ± 0.06 | 351 | 464 | 16 |
| FDA-6 | 134 | 3668.7 | 428.1 ± 9.5 | 5.55 ± 0.10 | 328 | 466 | 19 |
| FDA-7 | 140 | 3104.6 | 428.2 ± 5.5 | 5.82 ± 0.06 | 332 | 459 | 14 |
| FDA-8 | 132 | 3532.7 | 410.0 ± 2.4 | 5.67 ± 0.02 | 334 | 460 | 12 |
| FDA-9 | 123 | 3373.2 | 364.2 ± 3.6 | 5.38 ± 0.03 | 315 | 464 | 14 |
| FDMA-1 | 140 | 3994.7 | 386.7 ± 3.2 | 6.19 ± 0.04 | 317 | 454 | 16 |
| FDMA-2 | 145 | 3505.3 | 378.5 ± 0.8 | 6.17 ± 0.03 | 332 | 467 | 18 |
| FDMA-3 | 95, | 3209.5 | 358.7 ± 1.2 | 5.82 ± 0.06 | 335 | 466 | 17 |
| | 164 | | | | | | |
| FDMA-4 | 129 | 2781.4 | 403.7 ± 1.2 | 6.26 ± 0.02 | 344 | 464 | 17 |
| FDMA-5 | 135, | 4134.1 | 388.1 ± 3.5 | 5.78 ± 0.07 | 355 | 460 | 19 |
| | 177 | | | | | | |
| FDMA-6 | 147 | 3183.7 | 397.2 ± 1.8 | 6.14 ± 0.04 | 334 | 463 | 18 |
| FDMA-7 | 145 | 4829.3 | 395.7 ± 2.6 | 6.23 ± 0.02 | 327 | 461 | 19 |
| FDMA-8 | 133, | 4250.5 | 363.1 ± 10.5 | 5.78 ± 0.10 | 332 | 456 | 10 |
| | 176 | | | | | | |
| FDMA-9 | 103, | 3867.6 | 311.7 ± 1.7 | 5.37 ± 0.03 | 316 | 453 | 13 |
| | 175 | | | | | | |

TABLE 3
Nano-indentation hardness data

| | | Nano-indentation Hardness (MPa) | | |
|---|---|---|---|---|
| Diluents | | Numbers of Substitutions | | |
| | Substitution | 0 | 1 | 2 |
| Diacrylates | Methyl | 473.5 ± 1.5 | 438.3 ± 1.4 | 394.0 ± 1.4 |
| | Allyl | | 457.7 ± 2.9 | 469.5 ± 10.5 |
| | Cyclopentyl | | 428.1 ± 9.5 | 428.2 ± 5.5 |
| | Butyl | | 410.0 ± 2.4 | 364.2 ± 3.6 |
| Dimethacrylates | Methyl | 386.7 ± 3.2 | 378.5 ± 0.8 | 358.7 ± 1.2 |
| | Allyl | | 403.7 ± 1.2 | 388.1 ± 3.5 |
| | Cyclopentyl | | 397.2 ± 1.8 | 395.7 ± 2.6 |
| | Butyl | | 363.1 ± 10.5 | 311.7 ± 1.7 |

| | |
|---|---|
| HDDA | 350.4 ± 2 |

TABLE 4
Nano-indentation elastic modulus data

| | | Nano-indentation Elastic Modulus (GPa) | | |
|---|---|---|---|---|
| Diluents | | Numbers of Substitutions | | |
| | Substitution | 0 | 1 | 2 |
| Diacrylates | Methyl | 6.03 ± 0.02 | 5.93 ± 0.03 | 5.87 ± 0.02 |
| | Allyl | | 6.00 ± 0.04 | 5.73 ± 0.06 |
| | Cyclopentyl | | 5.55 ± 0.10 | 5.82 ± 0.06 |
| | Butyl | | 5.67 ± 0.02 | 5.38 ± 0.03 |
| Dimethacrylates | Methyl | 6.19 ± 0.04 | 6.17 ± 0.03 | 5.82 ± 0.06 |
| | Allyl | | 6.26 ± 0.02 | 5.78 ± 0.07 |
| | Cyclopentyl | | 6.14 ± 0.04 | 6.23 ± 0.02 |
| | Butyl | | 5.78 ± 0.10 | 5.37 ± 0.03 |

| | |
|---|---|
| HDDA | 5.39 ± 0.02 |

Dynamic Mechanical Analysis

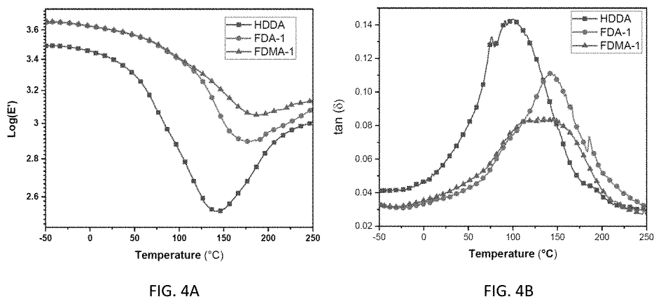

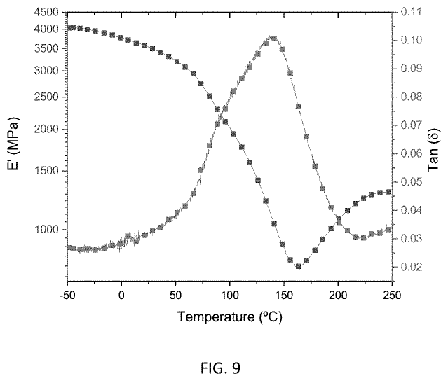

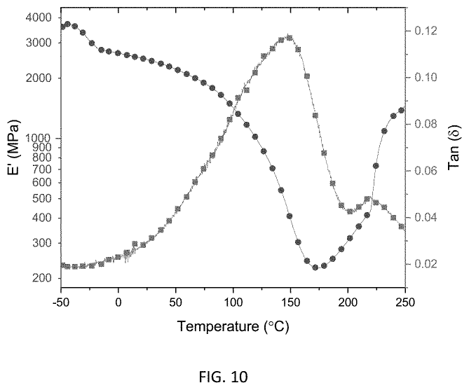

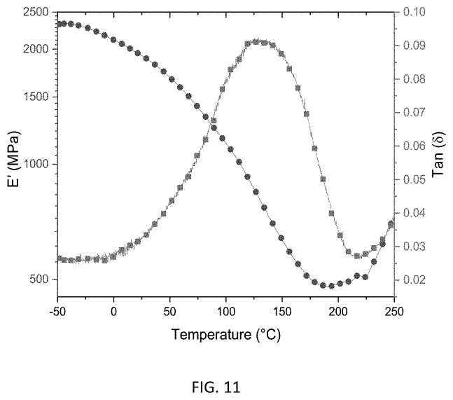

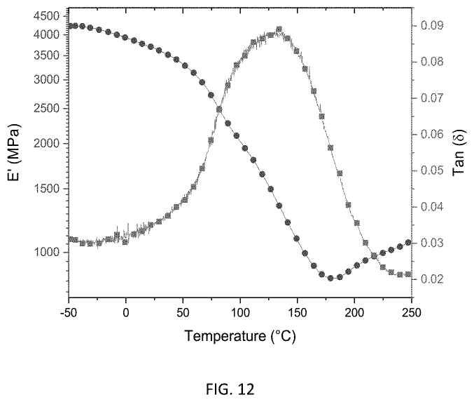

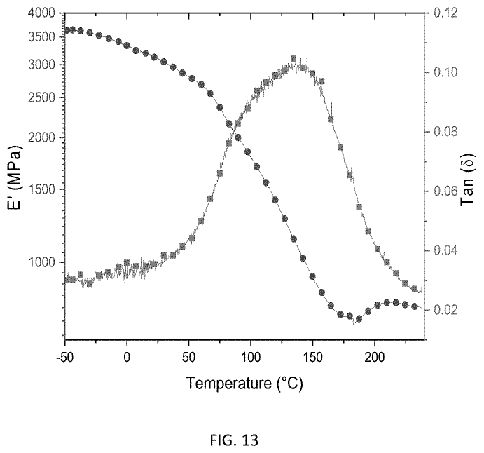

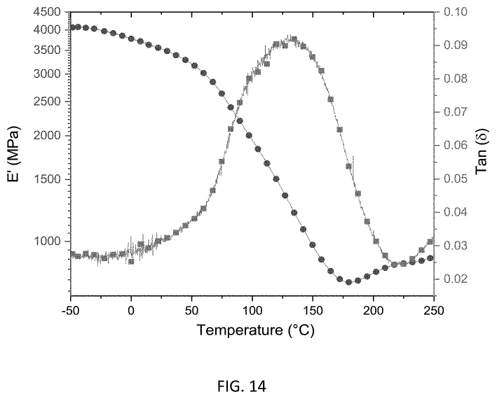

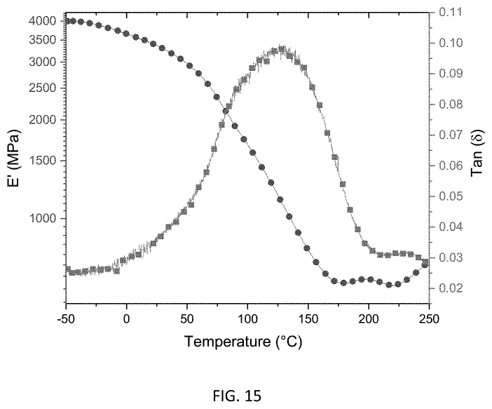

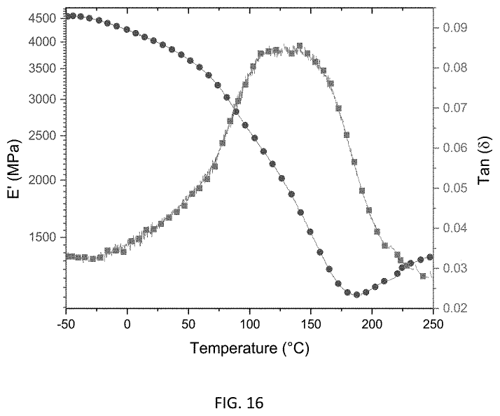

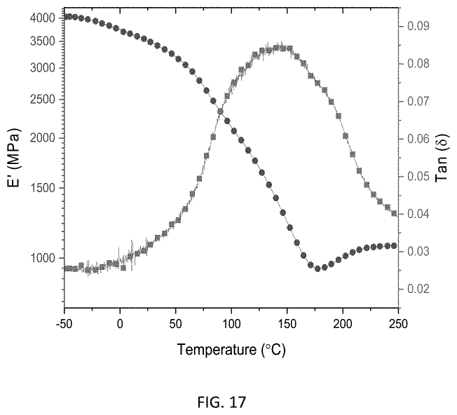

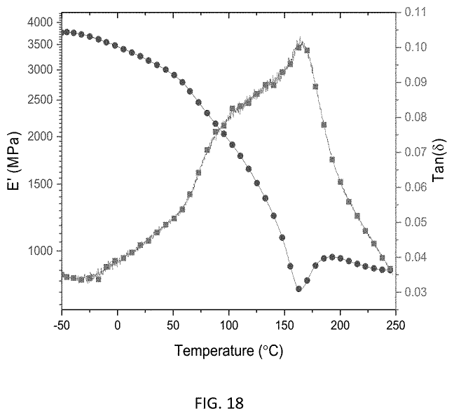

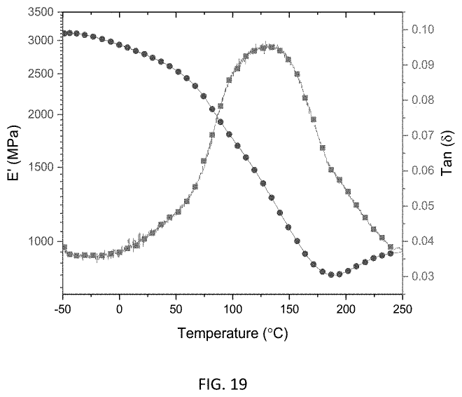

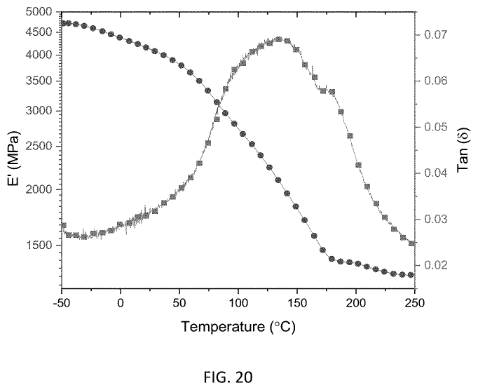

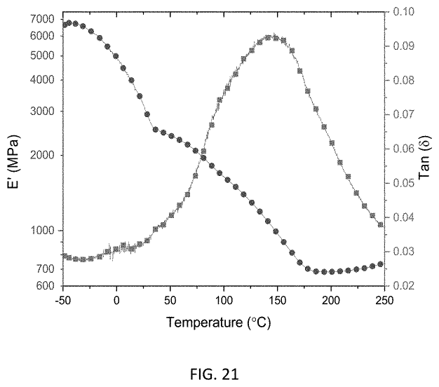

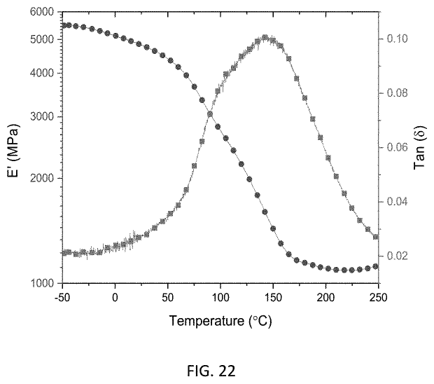

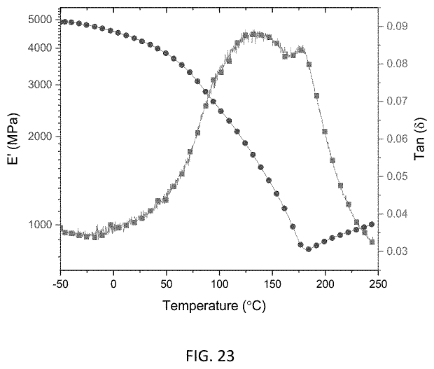

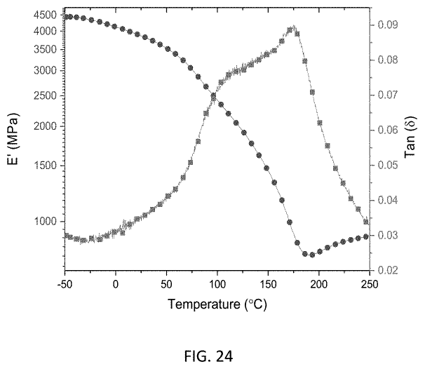

Dynamic mechanical analysis was carried out to study the viscoelastic properties of the coatings. The storage modulus (E′) and loss factor (tan δ) of the UV-cured film samples are shown in FIGS. 4A, 4B, and 9-24, and the related data are summarized in Table 2. In many of the storage modulus versus temperature plots, a significant rise in modulus is observed after the drop in modulus due to the phase transition at the glass transition temperature. This rise in modulus is likely due to additional curing that occurs once mobility is restored to the system. The glass transition temperature (T_{g}) was defined as the peak temperature of the tan δ curves. All FDA-4 based film samples broke during DMA tests because they are very brittle, so DMA data was not collected. As shown in Table 2, the cured furan-based FDA and FDMA film samples exhibit higher T_{g} than the cured control film sample, which is likely due to the planar and polar nature of the furan ring. Tan δ curves for some samples (e.g., FDA-3 based film sample) exhibited one large peak with a small peak or shoulder peak as shown in FIG. 10, which indicates the existence of phase separation for these coating systems. Where apparent multiple peaks were present in the tan δ curves, both temperatures are indicated.

The breadth of the tan δ peaks can be correlated to the extent of heterogeneity and damping characteristics of the cross-linked network.^{1, 36} Tan δ plots for most of the FDA and FDMA based coatings using furan-based diluents were slightly broader than the control HDDA coating and indicated more heterogeneous networks with more damping character for the furan-based diluent coatings compared to the control HDDA coating. FDA based coatings had somewhat narrower tan δ peaks compared to their corresponding FDMA based coatings, which indicated UV cured FDA based coatings form more homogeneous networks compared to their corresponding FDMA coatings. In the case of the acrylate functional diluents, the reactivity of the acrylate groups on the diluents and the urethane acrylate resin are similar, while in the case of the methacrylate functional diluents, there is a difference in reactivity. The variations in T_{g} are not only due to the changes in structures of the diluents, but the state of cure of the coating after UV curing. Since it was observed that these coatings have unreacted groups after UV curing, and this may vary from coating to coating, it is difficult to discern specific trends in the T_{g}s as a function of the substituents adjacent to the furan ring.

The FDA and FDMA samples except for FDA-3 and FDA-5 samples exhibit higher storage modulus at 25° C. than that of the control HDDA sample. These results suggested furan-based acrylate or methacrylate diluents are comparable with the current commercial diluents HDDA and formed coatings having higher modulus and higher T_{g}s.

Differential Scanning Calorimetry

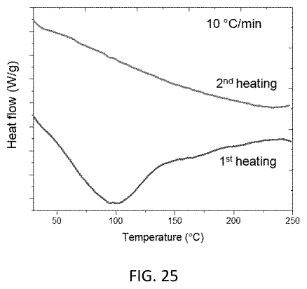

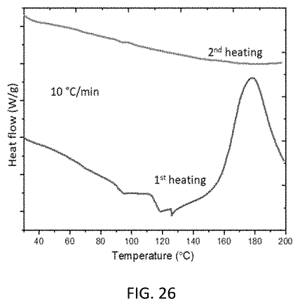

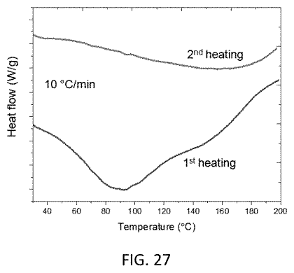

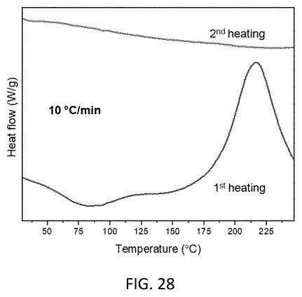

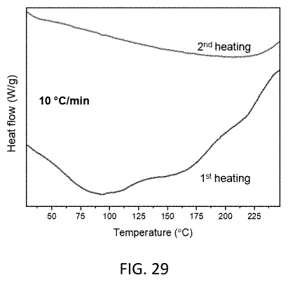

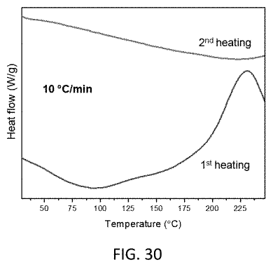

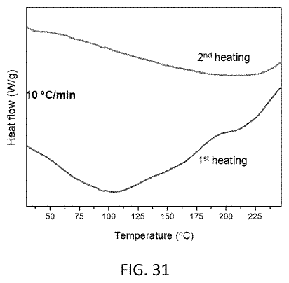

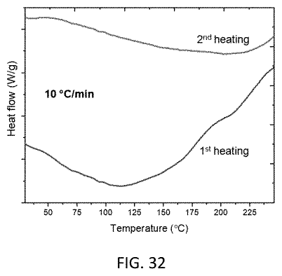

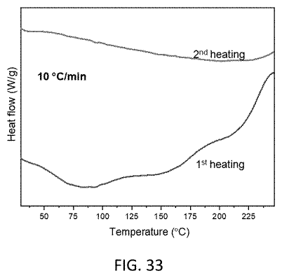

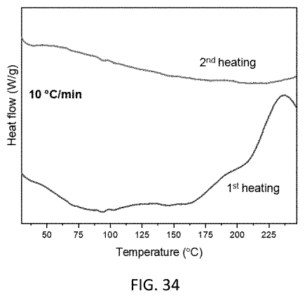

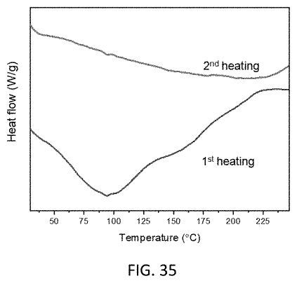

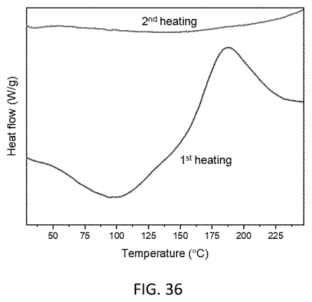

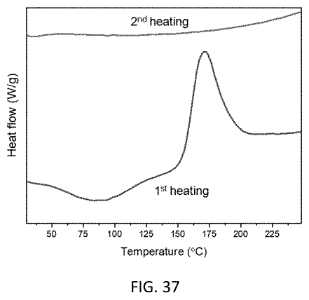

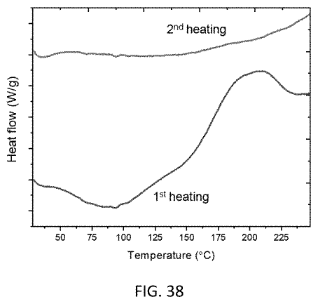

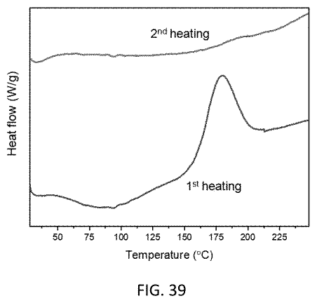

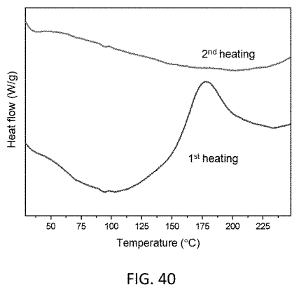

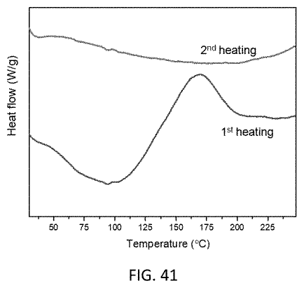

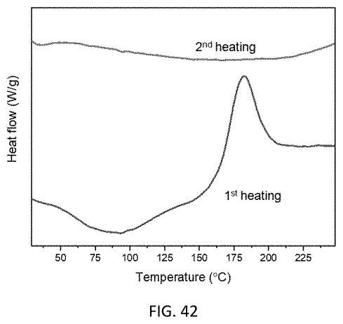

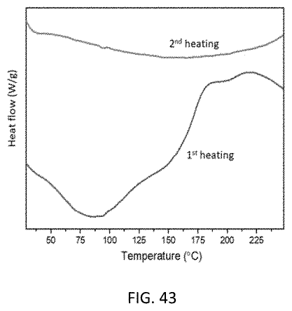

The DSC scans of the UV cured coatings do not exhibit obvious T_{g} transitions when heating coating samples in the second heating cycle (see FIG. 25-43 for details). As shown for example in FIG. 37, the DSC curve of the first heating cycle of FDMA-3 exhibited an exothermic transition in the temperature range 150-200° C., presumably associated with the polymerization reaction of residual double bonds of acrylate moieties from the formulation. This result is consistent with the FTIR studies where the ATR-FTIR spectra of the UV cured coatings showed a small amount of unreacted acrylate groups with a characteristic peak at 809 cm⁻¹. Many of the systems show an exothermic peak in the first heating cycle. This observation is also consistent with the increase in modulus seen above the T_{g} in the DMA storage modulus plots. The lack of obvious glass transitions in the second heating scan is indicative that a highly crosslinked polymer network was formed after the first heating cycle.

Thermogravimetric Analysis

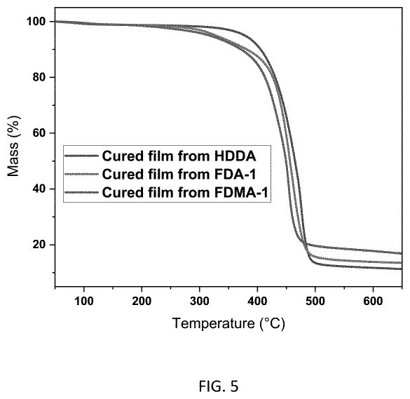

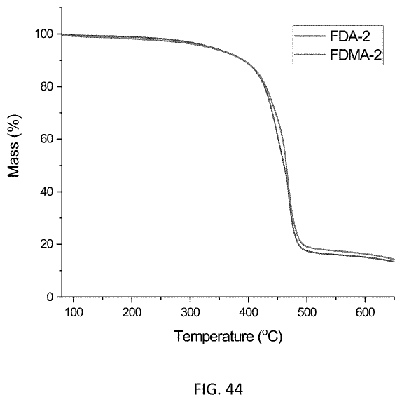

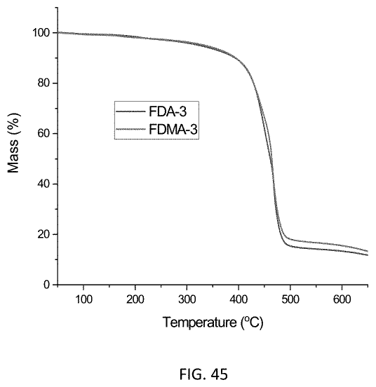

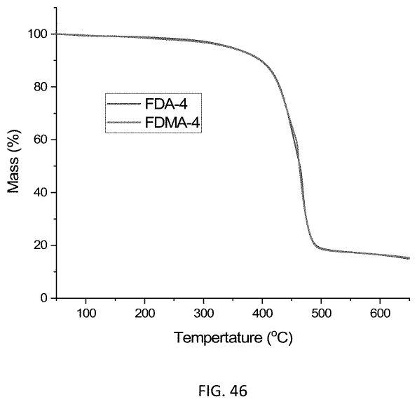

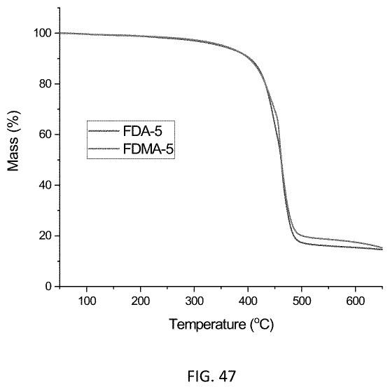

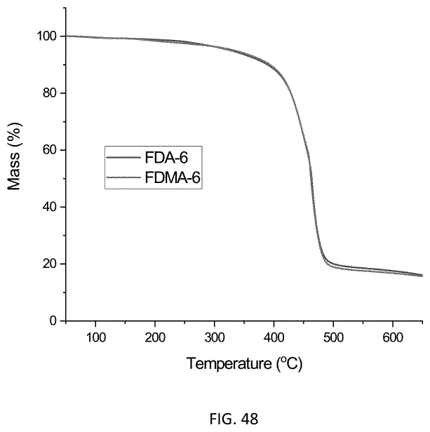

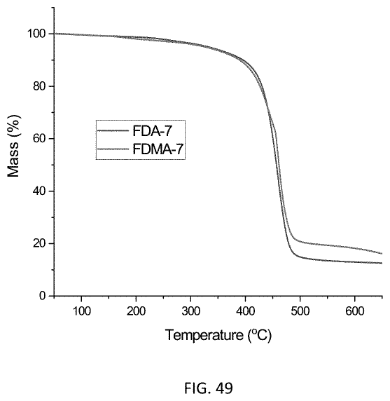

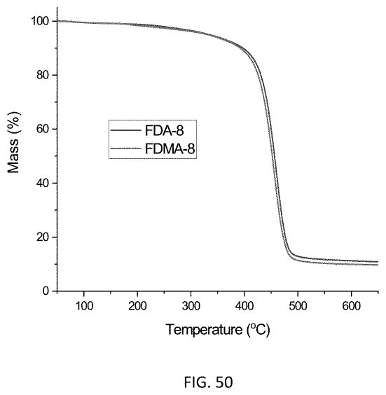

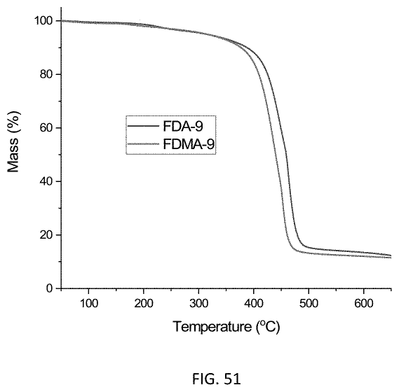

TGA analysis of the UV cured coatings is depicted in FIGS. 5 and 44-51 and the corresponding data involving 5% weight-loss temperature (Td^{5%}), Maximum thermal decomposition temperature (Tₚ), and char yield (W_{char}) are summarized in Table 2. The T_{d5%} values for all UV cured coatings are greater than 300° C., which indicates that the UV cured coatings have good thermal stability. The T_{d}^{5%} value for the control HDDA coating is higher than those of the FDA and FDMA based coatings, which indicates that the furan-based diluents lead to somewhat lower thermal stability than that of HDDA (e.g., FIG. 5). As shown in Table 2, all furan-based coatings except for FDMA-8 based coating had higher char yields than that of the control HDDA sample, which is likely due to the aromatic nature of the furan rings.³⁷⁻³⁹ As shown in FIG. 44-51, the cured coatings using acrylates as diluents have similar thermal stability to that of the methacrylate diluents. As shown in Table 2, in all furan-based UV cured samples, the samples prepared from furan-based diluents containing allyl groups (e.g., FDA-4, FDA-5, FDMA-4, and FDMA-5) exhibit higher thermal stability with higher T_{d}^{5%} values than those of the samples prepared from furan-based diluents containing alkyl or cyclic substituted groups, which may indicate that the allyl groups are involved in the UV curing process via chain transfer reactions and increase the stability of the cured samples. The cured films from the diluents containing two allyl groups (FDA-5 and FDMA-5) exhibit higher thermal stability than that of films from the diluent containing only one allyl group (FDA-4 and FDMA-4), which indicates incorporating more allyl groups along with acrylate groups into the coating formulation can improve the thermal stability of the cured films. In free radical polymerization, allyl groups can form radicals which can couple with other radicals in the system, increasing the crosslink density. Similar behavior using allyl vinyl veratrole as a reactive diluent in thermally cured systems was observed.¹⁴ The decomposition maxima were obtained for all cured film samples in the temperature range of 453-476° C. The control HDDA sample exhibited a slightly higher Tₚ than the furan-based simples, which indicates the main weight loss comes from the polyurethane resin.⁴⁰

Nanoindentation

To further characterize the mechanical properties of the UV cured coatings, nanoindentation experiments with a Berkovich indenter at a load of 2000 μN were performed and the Oliver and Pharr method was used to determine the elastic modulus and hardness of the samples. Nanoindentation has the advantage for testing of thin films because of a relatively small area utilized for the test. The contact depths are around 500 nm, which is much less than the thickness of the film samples. The elastic modulus and hardness data for UV cured film samples are included in Table 2. Tables 3 and 4 show the data arranged based on the substituent on the furan-based diols as well as the number of substituents. The furan-based samples have higher values of elastic modulus than that of the control HDDA sample except for FDA-9 and FDMA-9, which have similar elastic modulus to the control HDDA sample. All furan-based samples except for FDMA-9 have higher values of hardness than that of the control HDDA sample. Furan-based acrylate samples have higher values of hardness than those of their corresponding methacrylate samples. Most of the furan-based methacrylate samples except for FDMA-9 and FDMA-3 samples have higher elastic modulus values than that of their corresponding acrylate samples. The data also shows that the allyl group-containing diluents showed higher hardness and modulus than the alkyl substituted diluents, indicating that the allyl group may be participating in the free radical photopolymerization, as noted above.

### CONCLUSION

A series of acrylate and methacrylate diluents were synthesized from furan-based diols in good yields using a simple protocol. The furan-based diols were prepared from the readily available bio-based feedstock hydroxymethyl furfural (HMF). These furan-based acrylates and methacrylates were used as reactive diluents and formulated with a urethane acrylate resin to obtain UV curable coatings. The viscosities of furan-based diluents are low and comparable with commercially available diluent HDDA. UV cured coatings using furan-based diluents had excellent solvent resistant, good hardness, and high modulus. As described herein, furan-based diacrylates or dimethacrylates can be used as reactive diluents for high quality UV curable coatings.

### REFERENCES

1. Harkal, U. D.; Muehlberg, A. J.; Webster, D. C., UV curable glycidyl carbamate based resins. Progress in Organic Coatings 2012, 73 (1), 19-25.
2. Schwalm, R., CHAPTER 1—Introduction to Coatings Technology. In UV Coatings, Schwalm, R., Ed. Elsevier: Amsterdam, 2007; pp 1-18.
3. Rao, A. V.; Kanitkar, D. S.; Parab, A. K., Some speciality coatings from radiation curable poly(acrylic) combinations. Progress in Organic Coatings 1995, 25 (3), 221-233.
4. Silbert, S. D.; Simpson, P.; Setien, R.; Holthaus, M.; La Scala, J.; Ulven, C. A.; Webster, D. C., Exploration of Bio-Based Functionalized Sucrose Ester Resins for Additive Manufacturing via Stereolithography. ACS Applied Polymer Materials 2020, 2 (7), 2910-2918.
5. Lastovickova, D. N.; Toulan, F. R.; Mitchell, J. R.; VanOosten, D.; Clay, A. M.; Stanzione Iii, J. F.; Palmese, G. R.; La Scala, J. J., Resin, cure, and polymer properties of photopolymerizable resins containing bio-derived isosorbide. Journal of Applied Polymer Science 2021, 138 (25), a pp 50574.
6. Sohail, M.; Ashfaq, B.; Azeem, I.; Faisal, A.; Dogan, S. Y.; Wang, J.; Duran, H.; Yameen, B., A facile and versatile route to functional poly(propylene) surfaces via UV-curable coatings. Reactive and Functional Polymers 2019, 144, 104366.
7. Tathe, D. S.; Jagtap, R. N., Biobased reactive diluent for UV-curable urethane acrylate oligomers for wood coating. Journal of Coatings Technology and Research 2015, 12 (1), 187-196.
8. Hong, J. W.; Kim, H. K.; Yu, J. A.; Kim, Y. B., Characterization of UV-curable reactive diluent containing quaternary ammonium salts for antistatic coating. Journal of Applied Polymer Science 2002, 84 (1), 132-137.
9. Yu, A. Z.; Sahouani, J. M.; Webster, D. C., Highly functional methacrylated bio-based resins for UV-curable coatings. Progress in Organic Coatings 2018, 122, 219-228.
10. Gandini, A.; Lacerda, T. M.; Carvalho, A. J. F.; Trovatti, E., Progress of Polymers from Renewable Resources: Furans, Vegetable Oils, and Polysaccharides. Chemical Reviews 2016, 116 (3), 1637-1669.
11. Hevus, I.; Ricapito, N. G.; Tymoshenko, S.; Raja, S. N.; Webster, D. C., Biobased Carboxylic Acids as Components of Sustainable and High-Performance Coating Systems. ACS Sustainable Chemistry & Engineering 2020, 8 (14), 5750-5762.
12. Silbert, S. D.; Serum, E. M.; LaScala, J.; Sibi, M. P.; Webster, D. C., Biobased, Nonisocyanate, 2K Polyurethane Coatings Produced from Polycarbamate and Dialdehyde Cross-linking. ACS Sustainable Chemistry & Engineering 2019, 7 (24), 19621-19630.
13. Yu, A. Z.; Setien, R. A.; Sahouani, J. M.; Docken, J.; Webster, D. C., Catalyzed non-isocyanate polyurethane (NIPU) coatings from bio-based poly(cyclic carbonates). Journal of Coatings Technology and Research 2019, 16 (1), 41-57.
14. Yu, A. Z.; Serum, E. M.; Renner, A. C.; Sahouani, J. M.; Sibi, M. P.; Webster, D. C., Renewable Reactive Diluents as Practical Styrene Replacements in Biobased Vinyl Ester Thermosets. ACS Sustainable Chemistry & Engineering 2018, 6 (10), 12586-12592.
15. Veith, C.; Diot-Néant, F.; Miller, S. A.; Allais, F., Synthesis and polymerization of bio-based acrylates: a review. Polymer Chemistry 2020, 11 (47), 7452-7470.
16. Mannari, V.; Patel, C.; Li, W.; Kiamanesh, A., Soy-Based Building Blocks for Advanced Photocure Coating Systems. In Green Polymer Chemistry: Biobased Materials and Biocatalysis, American Chemical Society: 2015; Vol. 1192, pp 249-267.
17. Palanisamy, A.; Rao, B. S., Photo-DSC and dynamic mechanical studies on UV curable compositions containing diacrylate of ricinoleic acid amide derived from castor oil. Progress in Organic Coatings 2007, 60 (3), 161-169.
18. Hu, Y.; Feng, G.; Shang, Q.; Bo, C.; Jia, P.; Liu, C.; Xu, F.; Zhou, Y., Bio-based reactive diluent derived from cardanol and its application in polyurethane acrylate (PUA) coatings with high performance. Journal of Coatings Technology and Research 2019, 16 (2), 499-509.
19. Su, Y.; Zhang, S.; Zhou, X.; Yang, Z.; Yuan, T., A novel multi-functional bio-based reactive diluent derived from cardanol for high bio-content UV-curable coatings application. Progress in Organic Coatings 2020, 148, 105880.
20. Chu, Z.; Feng, Y.; Xie, B.; Yang, Y.; Hu, Y.; Zhou, X.; Yuan, T.; Yang, Z., Bio-based polyfunctional reactive diluent derived from tung oil by thiol-ene click reaction for high bio-content UV-LED curable coatings. Industrial Crops and Products 2021, 160, 113117.
21. van Putten, R.-J.; van der Waal, J. C.; de Jong, E.; Rasrendra, C. B.; Heeres, H. J.; de Vries, J. G., Hydroxymethylfurfural, A Versatile Platform Chemical Made from Renewable Resources. Chemical Reviews 2013, 113 (3), 1499-1597.
22. Sousa, A. F.; Vilela, C.; Fonseca, A. C.; Matos, M.; Freire, C. S. R.; Gruter, G.-J. M.; Coelho, J. F. J.; Silvestre, A. J. D., Biobased polyesters and other polymers from 2,5-furandicarboxylic acid: a tribute to furan excellency. Polymer Chemistry 2015, 6 (33), 5961-5983.
23. Xiong, X.; Yu, I. K. M.; Tsang, D. C. W.; Bolan, N. S.; Sik Ok, Y.; lgalavithana, A. D.; Kirkham, M. B.; Kim, K.-H.; Vikrant, K., Value-added chemicals from food supply chain wastes: State-of-the-art review and future prospects. Chemical Engineering Journal 2019, 375, 121983.
24. Deng, J.; Liu, X.; Li, C.; Jiang, Y.; Zhu, J., Synthesis and properties of a bio-based epoxy resin from 2,5-furandicarboxylic acid (FDCA). RSC Advances 2015, 5 (21), 15930-15939.
25. Meng, J.; Zeng, Y.; Chen, P.; Zhang, J.; Yao, C.; Fang, Z.; Guo, K., New ultrastiff bio-furan epoxy networks with high Tg: Facile synthesis to excellent properties. European Polymer Journal 2019, 121, 109292.
26. Kainulainen, T. P.; Erkkila, P.; Hukka, T. I.; Sirvio, J. A.; Heiskanen, J. P., Application of Furan-Based Dicarboxylic Acids in Bio-Derived Dimethacrylate Resins. ACS Applied Polymer Materials 2020, 2 (8), 3215-3225.
27. Hong, M.; Tang, X.; Falivene, L.; Caporaso, L.; Cavallo, L.; Chen, E. Y., Proton-Transfer Polymerization by N-Heterocyclic Carbenes: Monomer and Catalyst Scopes and Mechanism for Converting Dimethacrylates into Unsaturated Polyesters. Journal of the American Chemical Society 2016, 138 (6), 2021-35.
28. Zhang, D.; Dumont, M.-J., Functionalizable thermoresponsive polymers synthesized from renewable 5-hydroxymethylfurfural derivative via the thiol-Michael addition reaction. Polymer 2018, 145, 157-161.
29. Zhang, D.; Dumont, M.-J.; Cherestes, A., An efficient strategy for the synthesis of 5-hydroxymethylfurfural derivative based poly(β-thioether ester) via thiol-Michael addition polymerization. RSC Advances 2016, 6 (86), 83466-83470.
30. Sutton, C. A.; Polykarpov, A.; Jan van den Berg, K.; Yahkind, A.; Lea, L. J.; Webster, D. C.; Sibi, M. P., Novel Biobased Furanic Diols as Potential Alternatives to BPA: Synthesis and Endocrine Activity Screening. ACS Sustainable Chemistry & Engineering 2020, 8 (51), 18824-18829.
31. Oliver, W. C.; Pharr, G. M., An improved technique for determining hardness and elastic modulus using load and displacement sensing indentation experiments. Journal of Materials Research 1992, 7 (6), 1564-1583.
32. Karlinskii, B. Y.; Kostyukovich, A. Y.; Kucherov, F. A.; Galkin, K. I.; Kozlov, K. S.; Ananikov, V. P., Directing-Group-Free, Carbonyl Group-Promoted Catalytic C—H Arylation of Bio-Based Furans. ACS Catalysis 2020, 10 (19), 11466-11480.
33. Nyquist, R. A.; Fiedler, S.; Streck, R., Infrared study of vinyl acetate, methyl acrylate and methyl methacrylate in various solvents. Vibrational Spectroscopy 1994, 6 (3), 285-291.
34. Mercan, E. S.; Karaman, M., Coating of hydrophilic poly(hydroxypropyl methacrylate) thin films via pulsed-initiated chemical vapor deposition method. Journal of Coatings Technology and Research 2021, 18 (5), 1261-1268.
35. Vargun, E.; Usanmaz, A., Degradation of Poly(2-hydroxyethyl methacrylate) Obtained by Radiation in Aqueous Solution. Journal of Macromolecular Science, Part A 2010, 47 (9), 882-891.
36. Higginbottom, H. P.; Bowers, G. R.; Ferrell, P. E.; Hill, L. W., Cure of secondary carbamate groups by melamine-formaldehyde resins. Journal of Coatings Technology 1999, 71 (894), 49-60.
37. Mora, A.-S.; Tayouo, R.; Boutevin, B.; David, G.; Caillol, S., Synthesis of Pluri-Functional Amine Hardeners from Bio-Based Aromatic Aldehydes for Epoxy Amine Thermosets. Molecules 2019, 24 (18), 3285.
38. Nabipour, H.; Wang, X.; Song, L.; Hu, Y., A high performance fully bio-based epoxy thermoset from a syringaldehyde-derived epoxy monomer cured by furan-derived amine. Green Chemistry 2021, 23 (1), 501-510.
39. Hu, F.; Yadav, S. K.; La Scala, J. J.; Sadler, J. M.; Palmese, G. R., Preparation and Characterization of Fully Furan-Based Renewable Thermosetting Epoxy-Amine Systems. Macromolecular Chemistry and Physics 2015, 216 (13), 1441-1446.
40. Chattopadhyay, D. K.; Webster, D. C., Thermal stability and flame retardancy of polyurethanes. Prog. Polym. Sci. 2009, 34 (10), 1068-1133.

The claimed invention is:

1. A curable coating composition, comprising:
at least one acrylate functional oligomer;
at least one furan-based reactive diluent; and
at least one photoinitiator.

2. The curable coating composition of claim 1, wherein the acrylate functional oligomer is selected from the group consisting of a urethane acrylate oligomer, an epoxy acrylate oligomer, a polyester acrylate oligomer, a polyether acrylate oligomer, and mixtures thereof.

3. The curable coating composition of claim 2, wherein the urethane acrylate oligomer is selected from the group consisting of an aliphatic urethane acrylate oligomer, an aromatic urethane acrylate oligomer, and mixtures thereof.

4. The curable coating composition of claim 3, wherein the aliphatic urethane acrylate oligomer is a hexafunctional aliphatic urethane acrylate oligomer.

5. The curable coating composition of claim 1, wherein the acrylate functional oligomer is present in an amount ranging from about 20-90 PHR, based on the total weight of the curable coating composition.

6. The curable coating composition of claim 1, wherein the furan-based reactive diluent is selected from the group consisting of Formulae (I), (II), (III), and mixtures thereof: 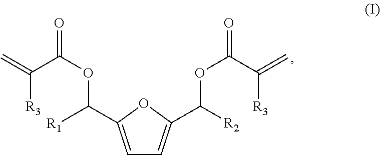
wherein:
R₁ and R₂ are, independent of one another, H, a C₁₋₆ alkyl, a C₂₋₆ alkenyl, a C₂₋₆ alkynyl, C₃₋₇ cycloalkyl, or aryl, wherein C₁₋₆ alkyl, C₂₋₆ alkenyl, C₂₋₆ alkynyl, C₃₋₇ cycloalkyl, and aryl are optionally substituted with substituents selected from OH, O—C₁₋₃ alkyl, and aryl, and wherein the C₃₋₇ cycloalkyl is optionally partially unsaturated and optionally at least one carbon atom in the cycloalkyl ring is replaced with a heteroatom; and
R₃ is, at each occurrence independent of one another, H or a C₁₋₆ alkyl; 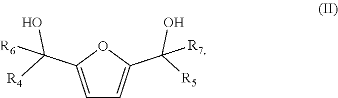
wherein:
R₄, R₅, R₆, and R₇ are independently selected from the group consisting of H, C₁-C₆ alkyl, C₂-C₆alkenyl, aryl, and C₁-C₆ alkyl-aryl; and 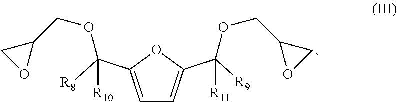
wherein:
R₈, R₉, R₁₀, and R₁₁ are independently selected from the group consisting of H, C₁-C₆ alkyl, C₂-C₆alkenyl, aryl, and C₁-C₆ alkyl-aryl.

7. The curable coating composition of claim 1, wherein the furan-based reactive diluent has the following structure of Formula (I): 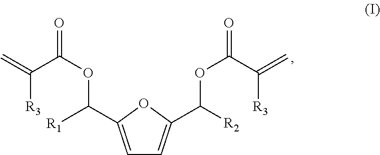
wherein:
R₁ and R₂ are, independent of one another, H, a C₁₋₆ alkyl, a C₂₋₆ alkenyl, a C₂₋₆ alkynyl, C₃₋₇ cycloalkyl, or aryl, wherein C₁₋₆ alkyl, C₂₋₆ alkenyl, C₂₋₆ alkynyl, C₃₋₇ cycloalkyl, and aryl are optionally substituted with substituents selected from OH, O—C₁₋₃ alkyl, and aryl, and wherein the C₃₋₇ cycloalkyl is optionally partially unsaturated and optionally at least one carbon atom in the cycloalkyl ring is replaced with a heteroatom; and
R₃ is, at each occurrence independent of one another, H or a C₁₋₆ alkyl.

8. The curable coating composition of claim 7, wherein:
R₁ and R₂ are, independent of one another, H, a C₁₋₄ alkyl, a C₂₋₄ alkenyl, and C₄₋₆ cycloalkyl; and
R₃ is, at each occurrence independent of one another, H or a C₁₋₃ alkyl.

9. The curable coating composition of claim 8, wherein:
R₁ and R₂ are, independent of one another, H, methyl, ethyl, propyl, butyl, —CH₂(CH═CH₂), or 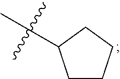 [SMILES: *C1CCCC1]
and
R₃ is H or methyl.

10. The curable coating composition of claim 9, wherein the furan-based reactive diluent is selected from:

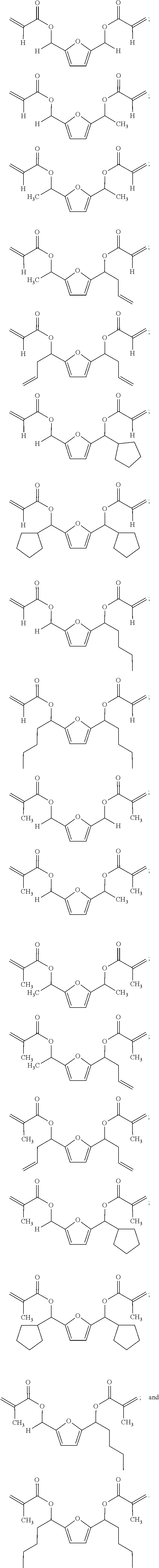

11. The curable coating composition of claim 1, wherein the furan-based reactive diluent is present in an amount of about 5-95 PHR, based on the total weight of the curable coating composition.

12. The curable coating composition of claim 1, wherein the furan-based reactive diluent comprises the reaction product of a furan-based diol and an acyl chloride.

13. The curable coating composition of claim 12, wherein the furan-based diol has the following structure: 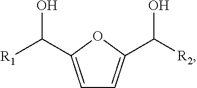
wherein:
R₁ and R₂ are, independent of one another, H, a C₁₋₆ alkyl, a C₂₋₆ alkenyl, a C₂₋₆ alkynyl, C₃₋₇ cycloalkyl, or aryl, wherein C₁₋₆ alkyl, C₂₋₆ alkenyl, C₂₋₆ alkynyl, C₃₋₇ cycloalkyl, and aryl are optionally substituted with substituents selected from OH, O—C₁₋₃ alkyl, and aryl, and wherein the C₃₋₇ cycloalkyl is optionally partially unsaturated and optionally at least one carbon atom in the cycloalkyl ring is replaced with a heteroatom; and
the acyl chloride has the following structure: 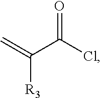
wherein R₃ is H or a C₁₋₆ alkyl.

14. A process for preparing the furan-based reactive diluents of claim 1, comprising:
adding triethylamine to a furan-based diol to form a first mixture; and
adding an acyl chloride to the first mixture.

15. The curable coating composition of claim 1, wherein the photoinitiator is present in an amount of about 0.5-10 PHR, based on the total weight of the curable coating composition.

16. A cured coating composition, wherein the curable coating composition of claim 1 is cured by radiation.

17. The cured coating composition of claim 16, wherein the radiation is ultraviolet radiation or visible light radiation.

18. An object or substrate coated with the curable coating composition of claim 1.

19. A method for improving the hardness, abrasion resistance, and/or durability of an object or a substrate, comprising the steps of:
coating at least a portion of a surface of the object or the substrate with the curable coating composition of claim 1 to form a coated surface, and
curing the curable coating composition on the coated surface.

20. A method of making the curable coating composition of claim 1 comprising combining the at least one urethane acrylate oligomer, the at least one furan-based reactive diluent, and the at least one photoinitiator.
